(19) United States
(12) Patent Application Publication
(10) Pub. No.: US 2007/0295311 A1
(43) Pub. Date: Dec. 27, 2007

(54) Fuel injection system having variable pressure fuel pump

(76) Inventors: Matthew R. McCue, Palm Springs, CA (US); Don Schafer, Napa, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/472,970

(22) Filed: Jun. 22, 2006

(51) Int. Cl. F02M 69/22; F02M 51/00

(52) U.S. Cl. 123/497; 123/453; 123/482

(57) ABSTRACT

The present invention provides a constant flow fuel injection system for an engine, the system comprising an engine control unit, a variable DC brushless motor fuel pump, and a constant orifice fuel injector, wherein the engine control unit drives the fuel pump to provide fuel pressure to the fuel injector by modulating the fuel pump pressure to vary the fuel flow rate to the fuel injector.

### FIELD OF THE INVENTION

The present invention relates generally to fuel injectors and, more particularly, to a fuel injection system having a variable pressure fuel pump.

### BACKGROUND OF THE INVENTION

For engines having less than about 300 cubic centimeters of displacement, fuel metering and delivery is commonly done with miniature diaphragm carburetors. These diaphragm carburetors represent early 20th century technology. In particular, such diaphragm carburetors: (1) require continuous needle valve adjustments; (2) have poor needle and RPM transitions; (3) have poor fuel distribution; and (4) have poor fuel atomization.

With the recent focus on small gasoline two-stroke emissions, a need to better meter and more efficiently burn fossil fuels exists. Previous efforts to provide fuel injection systems for engines having less than 300 cubic centimeters in displacement have been focused on the use of automotive style fuel injection systems that rely on an electric solenoid to pulse the amount of fuel into the engine by varying the pulse length of fuel flow at a constant pressure. Such systems may require the miniaturization of the feedback sensors.

It should, therefore, be appreciated that there exists a need for a fuel injection system having a variable pressure fuel pump.

### SUMMARY OF THE INVENTION

In view of the foregoing, it is an object of the present invention to provide a fuel injection system having a variable pressure fuel pump.

The present invention provides a fuel injection system having a variable pressure fuel pump including electronic engine management, fuel pressurization through a variable DC brushless motor fuel pump, and an injector orifice. The system preferably utilizes barometric pressure and input temperature feedback sensors to provide automatic mixture control at various atmospheric conditions.

One aspect of the invention involves a variable pressure fuel pump fuel injection system for an engine, the system comprising an engine control unit, a variable DC brushless motor fuel pump and an orifice fuel injector, wherein the engine control unit drives the fuel pump to provide fuel pressure to the fuel injector by modulating the fuel pump pressure to vary the fuel flow rate to the fuel injector. The fuel injection system may further comprise a plurality of sensors, including an engine speed sensor, an intake air temperature sensor, a cylinder head temperature sensor and a barometric pressure sensor. In operation, the engine control unit determines a required duty cycle of the fuel pump to produce a predetermined pressure and fuel flow to the fuel injector, wherein the required duty cycle is based upon a power setting and sensor readings of the plurality of sensors.

According to the invention, the engine control unit includes control logic comprising machine readable or interpretable instructions for controlling fuel injection via the fuel pump. In particular, the engine control unit meters fuel flow by driving the fuel pump to provide fuel pressure to the orifice fuel injector. The fuel pump is driven by a DC motor controller that uses duty cycle to throttle the pump speed and the fuel flow to the engine. The engine control unit may also be configured to accommodate various fuel map compensations native to automotive fuel injection systems, including intake air temperature compensation system voltage compensation, and cylinder head temperature compensation.

A preferred fuel delivery system to the engine of the invention comprises a throttle body that houses an injector including an injection nozzle having a fuel outlet, and a throttle plate that regulates the flow of air into the engine. Additionally, the fuel injection system may be configured to adjust fuel mixture based upon changes in atmospheric air pressure, which is measured using a barometric pressure sensor. More particularly, the engine control unit may command an air pressure control to automatically compensate for variance in atmospheric pressure due to changes in altitude and climate.

Another aspect of the invention involves a variable pressure fuel pump fuel injection system for an engine, the system comprising an engine control unit, a variable DC brushless motor fuel pump, a fuel injector, and a plurality of sensors, including an engine speed sensor, an intake air temperature sensor, a cylinder head temperature sensor and a barometric pressure sensor, wherein the engine control unit drives the fuel pump to provide fuel pressure to the fuel injector by modulating the fuel pump pressure to vary the fuel flow rate to the fuel injector, and wherein the engine control unit determines a required duty cycle of the fuel pump to produce a predetermined pressure and fuel flow to the fuel injector. The required duty cycle is based upon a power setting and sensor readings of the plurality of sensors. In addition, the engine control unit is configured to accommodate various fuel map compensations native to automotive fuel injection systems, including intake air temperature compensation system voltage compensation, and cylinder head temperature compensation.

A further aspect of the invention involves a variable pressure fuel pump fuel injection system for an engine, the system comprising an engine control unit, a variable DC brushless motor fuel pump, and a fuel injector, wherein the engine control unit drives the fuel pump to provide fuel pressure to the fuel injector by modulating the fuel pump pressure to vary the fuel flow rate to the fuel injector, and wherein the fuel injector comprises a throttle body that houses an injector including an injection nozzle having a fuel outlet. The throttle body may further comprise a throttle plate to regulate the flow of air into the engine, which throttle body comprises an injector that provides an increase in combustion efficiency due to the atomization of the fuel.

Other features and advantages of the present invention should become apparent from the following description of the preferred embodiments, taken in conjunction with the accompanying drawings, which illustrate, by way of example, the principles of the invention.

### BRIEF DESCRIPTION OF THE DRAWINGS

Embodiments of the present invention will now be described, by way of example only, with reference to the following drawings, in which:

FIG. 1 illustrates a schematic view of the preferred fuel injection system in accordance with the principles of the present invention;

FIG. 2 illustrates a perspective view of the preferred fuel injection system in accordance with the principles of the present invention; and

FIGS. 3A-3C illustrate a preferred throttle body in accordance with the principles of the invention; wherein FIG. 3A depicts a front view of the throttle body; FIG. 3B illustrates a side view of the throttle body; and FIG. 3C depicts a cross-sectional view of the throttle body of FIG. 3A taken along line C-C.

### DETAILED DESCRIPTION OF THE PREFERRED EMBODIMENTS

The present invention is directed to a fuel injection system having a variable pressure fuel pump including electronic engine management, fuel pressurization through a variable DC brushless motor fuel pump, and an injector orifice. The system preferably has the ability to provide automatic mixture control at various atmospheric conditions, the system including barometric pressure and input temperature feedback sensors. According to some embodiments, the system is miniaturized for use in small engine platforms. Rather than miniaturizing an automotive style injector that relies on an electric solenoid to pulse the amount of fuel into the engine by varying the pulse length of fuel flow at a constant pressure, the system of the invention varies the fuel pump pressure to vary the fuel flow rate. Such a system may be more easily and inexpensively miniaturized for use in small engines. Additionally, a more reliable and more efficient propulsion system can be created by incorporating feedback regarding engine health and present atmospheric conditions.

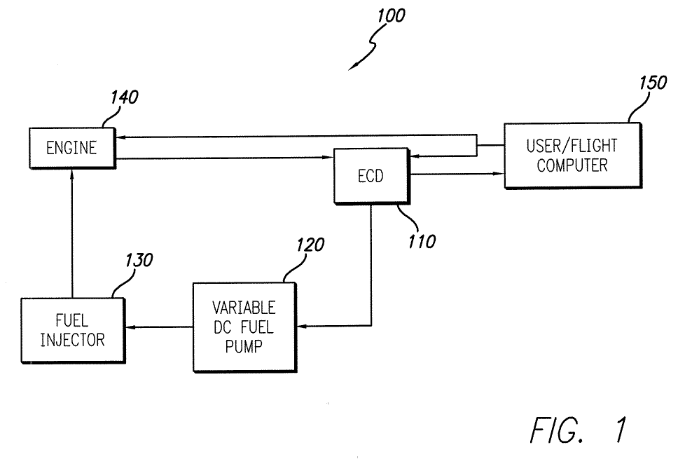

Referring to FIG. 1, a preferred fuel injection system 100 of the invention comprises an engine control unit (ECU) 110, a variable DC brushless motor fuel pump 120, a fuel injector 130, and engine 140 and a user/flight computer 150 which provides the system with its commanded input or desired throttle setting. In particular, the system 100 comprises an arrangement that requires a command logic or manual adjustment to control a power setting of the engine 140. In operation, the ECU 110 drives the variable DC brushless motor fuel pump 120 to provide fuel pressure to the fuel injector 130. Specifically, the ECU 110 modulates the fuel pump pressure to vary the fuel flow rate to the fuel injector 130. The fuel pump 120 uses duty cycle to throttle the fuel flow to the engine 140.

According to the invention, the fuel injection system 100 further comprises a plurality of sensors, including, but not limited to: (1) an engine speed sensor (RPM); (2) an intake air temperature sensor (IAT); (3) a cylinder head temperature sensor (CHT); and (4) a barometric pressure sensor (BARO). Based upon the power setting and input conditions (i.e, sensor readings), the ECU 110 determines the required duty cycle of the variable DC brushless motor fuel pump 120 to produce the required pressure and fuel flow to the fuel injector 130.

The hardware required to satisfy the fuel injection system 100 of the invention is fewer than that of an automotive constant pressure, variable fuel pulse width injection system. Specifically, a conventional automotive fuel injector system typically includes a DC brushed fuel pump, a fuel pressure regulator, a fuel return line, solenoid fuel injectors, a throttle position sensor, a manifold air pressure sensor, an intake air temperature sensor, and an engine control unit. By contrast, the fuel injection system 100 described herein includes the variable duty cycle DC brushless motor fuel pump 120, the fuel injector 130, the intake air temperature sensor (IAT), the cylinder head temperature sensor (CHT), and the ECU 110. The conventional automotive system requires one or more solenoid driven fuel injectors that are fed a constant pressure supply of fuel that must be constantly regulated. The complexity and geometric constraints of the automotive injectors, fuel pumps, sensors and pressure regulators are much more costly and complex than that of the variable pump pressure fuel injection system 100. Additional benefits of the system 100 include a significant reduction in this size of the injector element (i.e., fuel injector 130), as well as the absence of a need for pressure regulators to regulate the fuel system 100.

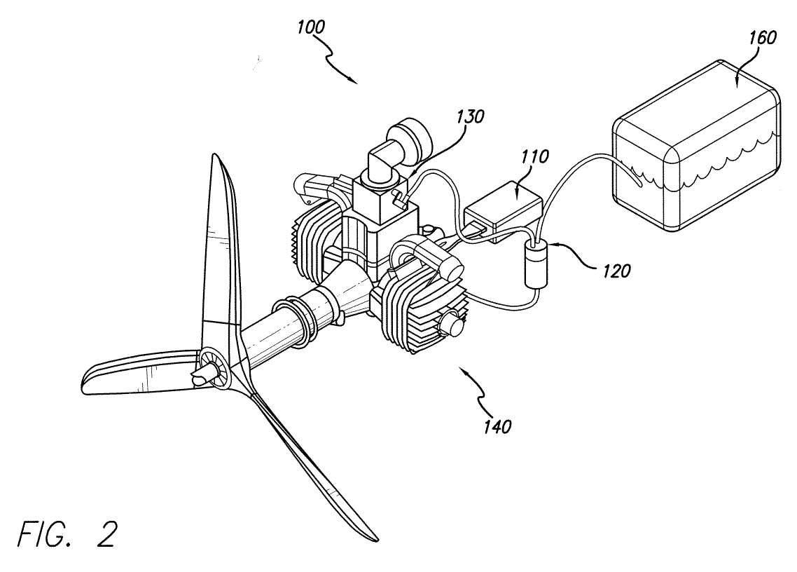

Referring to FIG. 2, the variable pump pressure fuel injection system 100 includes the engine control unit 110, the variable duty cycle DC brushless fuel pump 120, the fuel injector 130, the engine 140, and a fuel tank 160. According to a preferred implementation, the engine control unit 110 comprises a custom piece of hardware that has been miniaturized to be able to drive a long life DC brushless motor at relatively high pressures (e.g., 0-120 PSI). The ECU 110 includes control logic comprising machine readable or interpretable instructions for controlling fuel injection using the variable duty cycle DC brushless motor fuel pump 120. In operation, the ECU 110 meters fuel flow by driving the fuel pump 120 to provide fuel pressure to the fuel injector 130. Specifically, the ECU 110 modulates the fuel pump pressure to vary the fuel flow rate to the fuel injector 130. The fuel pump 120 is driven by a DC motor controller that uses duty cycle to throttle the pump speed and the fuel flow to the engine 140. By way of example, the fuel pump 120 may comprise a positive gear pump.

The ECU 110 may be configured to accommodate various fuel map compensations native to automotive fuel injection systems, including without limitation: (1) intake air temperature compensation; (2) system voltage compensation; and (3) cylinder head temperature compensation. As set forth hereinabove, the intake air temperature and cylinder head temperature as determined using the air temperature sensor (IAT) and the cylinder head temperature sensor (CHT), respectively. According to the invention, the fuel injection system 100 may be configured to adjust fuel mixture based upon changes in atmospheric air pressure. Specifically, the ECU 110 measures intake barometric pressure using the barometric pressure sensor (BARO). More particularly, the ECU commands an air pressure control to automatically compensate for variance in atmospheric pressure due to changes in altitude and climate.

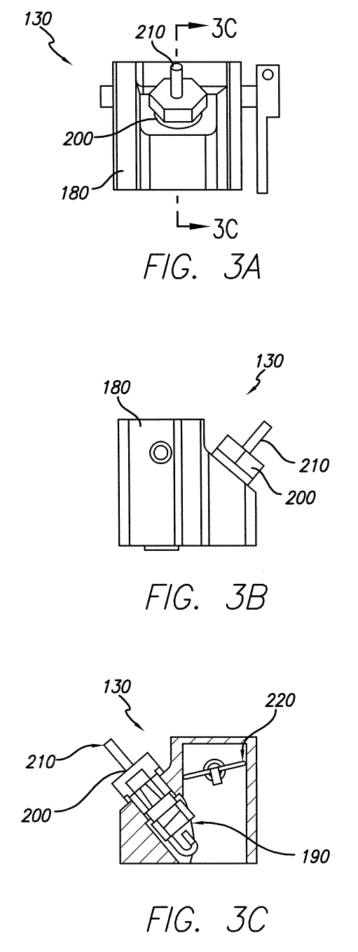

FIGS. 3A-3C illustrate a preferred throttle body fuel injector 130 of the present invention. Particularly, FIG. 3A depicts a front view of the fuel injector 130, FIG. 3B illustrates a side view of the fuel injector 130, and FIG. 3C depicts a cross-sectional view fuel injector of FIG. 3A taken along line C-C. The throttle body fuel injector 130 comprises a throttle body 180 that houses an injector 190 including an injection nozzle 200 having a fuel outlet 210, and a throttle plate 220 to regulate the flow of air into the engine. The fuel injector 130 may be designed to replace conventional stock diaphragm carburetors currently used by a wide variety of two-stroke and four-stroke engines. The fuel injector 190 provides an increase in combustion efficiency due to the atomization of the fuel. In addition, the injector 190 is preferably manufactured in a variety of orifice diameters to provide different flow rates during operation.

The present invention has been described above in terms of presently preferred embodiments so that an understanding of the present invention can be conveyed. However, there are other embodiments not specifically described herein for which the present invention is applicable. Therefore, the present invention should not to be seen as limited to the forms shown, which is to be considered illustrative rather than restrictive.

Thus, it is seen that a fuel injection system having a variable pressure fuel pump is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well. Therefore, the present invention should not be seen as limited to the forms shown, which is to be considered illustrative rather than restrictive.

1. A constant flow fuel injection system for an engine, the system comprising:
an engine control unit;
a variable DC brushless motor fuel pump; and
a constant orifice fuel injector;
wherein the engine control unit drives the fuel pump to provide fuel pressure to the fuel injector by modulating the fuel pump pressure to vary the fuel flow rate to the fuel injector.

2. The fuel injection system of claim 1, further comprising a plurality of sensors, including an engine speed sensor, an intake air temperature sensor, a cylinder head temperature sensor and a barometric pressure sensor.

3. The fuel injection system of claim 1, wherein the engine control unit determines a required duty cycle of the fuel pump to produce a predetermined pressure and fuel flow to the fuel injector.

4. The fuel injection system of claim 3, wherein the required duty cycle is based upon a power setting and sensor readings of the plurality of sensors

5. The fuel injection system of claim 1, wherein the engine control unit includes control logic comprising machine readable or interpretable instructions stored on a computer readable medium for controlling fuel injection via the fuel pump.

6. The fuel injection system of claim 1, wherein the engine control unit meters fuel flow by driving the fuel pump to provide fuel pressure to the constant orifice fuel injector.

7. The fuel injection system of claim 1, wherein the engine control unit modulates the fuel pump pressure to vary the fuel flow rate to the fuel injector.

8. The fuel injection system of claim 1, wherein the fuel pump is driven by a DC motor controller that uses duty cycle to throttle the pump speed and the fuel flow to the engine.

9. The fuel injection system of claim 1, wherein the engine control unit is configured to accommodate various fuel map compensations native to automotive fuel injection systems, including intake air temperature compensation system voltage compensation, and cylinder head temperature compensation.

10. The fuel injection system of claim 1, wherein the system is configured to adjust fuel mixture based upon changes in atmospheric air pressure, which is measured using a barometric pressure sensor.

11. The fuel injection system of claim 1, wherein the engine control unit commands an air pressure control to automatically compensate for variance in atmospheric pressure due to changes in altitude and climate.

12. The fuel injection system of claim 1, wherein the fuel injector comprises a throttle body that houses an injector including an injection nozzle having a fuel outlet.

13. The fuel injections system of claim 12, further comprising a throttle plate to regulate the flow of air into the throttle body.

14. The fuel injection system of claim 12, wherein the injector comprises a constant diameter orifice impingement injector that provides automated fuel mixture compensation and an increase in combustion efficiency due to the atomization of the fuel.

15. A constant flow fuel injection system for an engine, the system comprising:
an engine control unit;
a variable DC brushless motor fuel pump;
a constant orifice fuel injector; and
a plurality of sensors, including an engine speed sensor, an intake air temperature sensor, a cylinder head temperature sensor and a barometric pressure sensor;
wherein the engine control unit drives the fuel pump to provide fuel pressure to the fuel injector by modulating the fuel pump pressure to vary the fuel flow rate to the fuel injector;
wherein the engine control unit determines a required duty cycle of the fuel pump to produce a predetermined pressure and fuel flow to the fuel injector.

16. The fuel injection system of claim 15, wherein the required duty cycle is based upon a power setting and sensor readings of the plurality of sensors

17. The fuel injection system of claim 15, wherein the engine control unit is configured to accommodate various fuel map compensations native to automotive fuel injection systems, including intake air temperature compensation system voltage compensation, and cylinder head temperature compensation.

18. A constant flow fuel injection system for an engine, the system comprising:
an engine control unit;
a variable DC brushless motor fuel pump; and
a constant orifice fuel injector;
wherein the engine control unit drives the fuel pump to provide fuel pressure to the fuel injector by modulating the fuel pump pressure to vary the fuel flow rate to the fuel injector;
wherein the fuel injector comprises a throttle body that houses an injector including an injection nozzle having a fuel outlet.

19. The fuel injection system of claim 18, wherein the fuel injector further comprises a throttle plate to regulate the flow of air into the throttle body.

20. The fuel injection system of claim 18, wherein the injector comprises a constant diameter orifice impingement injector that provides automated fuel mixture compensation and an increase in combustion efficiency due to the atomization of the fuel.
